(19) United States
(12) Patent Application Publication
(10) Pub. No.: US 2003/0236926 A1
(43) Pub. Date: Dec. 25, 2003

(54) Method of propagating invocation contexts through a distributed object system

(75) Inventors: Eric Malville, Bayeux (FR); Michel Milhau, Cairon (FR)

Correspondence Address: COHEN, PONTANI, LIEBERMAN & PAVANE, Suite 1210, 551 Fifth Avenue, New York, NY, 10176, US

(73) Assignee: France Telecom, Paris (FR)

(21) Appl. No.: 10/427,874

(22) Filed: Apr. 30, 2003

Related U.S. Application Data
(63) Continuation of application No. PCT/FR01/03120, filed on Oct. 10, 2001.

(30) Foreign Application Priority Data
Oct. 30, 2000 (FR) 00/13917

(51) Int. Cl. G06F 9/46; G06F 9/00

(52) U.S. Cl. 709/328

(57) ABSTRACT

A method of propagating invocation contexts through a distributed object system that includes an application management API interface and wherein each object is associated with an interceptor and with a manager of the context of an incoming request received by the interceptor when the object is invoked. A thread manager is provided for the interceptor for the purpose, firstly, of establishing an association between a thread of an object directly consecutive to an incoming request invoking the object and the context of the incoming request as identified by the context manager and, secondly, of recovering the context from the thread manager and associating it with the outgoing request from the object. A method is added to the application management API interface enabling it to recover the current context from the thread manager and to associate it with any thread of the object indirectly consecutive to the incoming request.

This is a continuation of International Application No. PCT/FR01/03120 designating the USA.

### FIELD OF THE INVENTION

The present invention relates to a method of propagating invocation contexts through a distributed object system.

### BACKGROUND OF THE INVENTION

An advantageous application of the invention lies in all cases where it is necessary to know, in particular by their contexts, the causal order of interactions between objects, i.e. to know for each invocation (used interchangeably herein with “request”) which invocations have been generated thereby. The services offered by this type of distributed object system are implemented by interactions between the objects making up the system, with the invocation of a service thus being capable of generating a succession of invocations to methods of different objects.

Various terms are used herein which are describable as follows.

An interface is a set of methods (also called services).

An object is a software component that implements one or more interfaces (i.e. the object provides the services of this interface).

Referring to FIG. 8, the term initiator refers to a role. One can distinguish two groups of roles:

Client/Server: Typically, an object can play the role of a client and/or a server (it will do so often simultaneously). For instance, the object B is a client of the object C and also a server for the object A.

Initiator/Intermediary/Target:

An initiator is the entity standing at the beginning of an invocation chain. It is an object or a user that acts on its own behalf.

An intermediary, on the contrary, is an object that acts on somebody else's behalf (i.e. on behalf of another object or a user).

A target is the object that stands at the end of the invocation chain. It does not need any help to provide the requested service.

The term “context” or “invocation context” is a general term that refers to a set of information specifying the way an invocation is performed, i.e. the conditions under which the invocation is performed. The context could include information about the initiator (e.g. its identity, its IP address), information about each intermediary (e.g. their identity, their IP address), and information about the security level of each communication link (in terms of confidentiality and integrity).

The term thread is defined at http://java.about.com/library/glossary/bldef-thread.htm as: “The basic unit of program execution in the Java Virtual Machine (JVM). A process can have several threads running concurrently, each performing a different job. When a thread has finished its job, it is suspended or destroyed.”

Another definition from from the Java Tutorial (http://java.sun.com/docs/books/tutorial/essential/thread s/definition.html) is: “A thread is a single sequential flow of control within a program.”

One other way of looking at it is that, whereas a method corresponds to a sequence of instructions (static part of an object), a thread is the actual execution of a method (dynamic part of the object).

The invention can be applied to security in distributed object systems. It frequently happens that access to a method of an object is conditioned by the identity of the initiator, usually the user (i.e. a person). In order to control access to the methods of objects, it is therefore necessary to supply the identity of the client to all of the objects contributing to implementing the requested service.

In other applications, such as supervision or audit, it is also necessary to know the identity, and more generally the context, of the various intermediaries that have contributed to implementing the service.

The Common Object Request Broker Architecture (CORBA) is a specification from the Object Management Group (OMG). Regarding CORBA, see http://www.omg.org/docs/formal/01-12-01.pdf (pdf) and http://www.omg.org/cgi-bin/doc?formal/01-12-01 (other formats). OMG is an open membership, not-for-profit consortium that produces and maintains computer industry specifications for interoperable enterprise applications. More details are available at www.omg.org. OMG proposes various specifications for developing object-oriented communications infrastructures. See the OMG publication, “The Common Object Request Broker: Architecture and Specification,” Revision 2.6, December 2001.

The OMG specifications include specifications for interceptors (see the above-mentioned OMG publication for details). Interceptors are interposed between the object request broker (ORB—see the above-mentioned OMG publication for details), the core of the communications infrastructure, and application objects, and they serve to process incoming and outgoing requests in a manner that is transparent for the application objects. They are thus naturally used for implementing those services that are to be transparent (i.e. that the objects are not aware of the fact that a context is propagated from object to object. The code of the object does not need to be modified or to include a specific instruction) for application objects: audits, access control, supervision, etc.

Certain implementations of those CORBA specifications propose an interceptor service. However, none of those implementations enables information to be propagated transparently. It thus becomes impossible in some cases to implement services that are totally transparent for application objects.

Interceptors thus make it possible to implement actions on incoming or outgoing requests in a manner that is transparent for a CORBA object. However, most ORBs implementing this notion of an interceptor do not provide a mechanism for propagating information transparently. The problem lies in the fact that an interceptor has no way of knowing in all cases what is the relationship between incoming requests and outgoing requests. In order to provide a transparent propagation mechanism, it is necessary for an interceptor to know, for each outgoing request, whether it is consecutive to an incoming request and, if so, which incoming request or whether it is a request that has been sent spontaneously by the object.

As can be seen in FIG. 1, which shows the mechanism for invoking an application object in a known interceptor system, when an application object receives an invocation, a new, directly consecutive thread A₁ for processing the invocation is created by means of an application programming interface (API) that manages threads. Most of the programming languages, such as Java and C/C++, provide such an API to manage (e.g. create, suspend, resume, . . . ) threads. The received request can also give rise to a new, indirectly consecutive thread A₂ being created that is dedicated to invocation of another object.

Let us say that a context manager (see below) identifies the context of the invocation and thus of the thread created. If the object uses the same thread A₁ for implementing an invocation of another object, the interceptor can verify directly whether this is an outgoing request consecutive to the incoming request and can associate therewith the context as identified by the context manager. This would be the only circumstance that does not raise any ambiguity. Suppose that the received request gives rise to the new thread A₂, then the interceptor can no longer know whether this invocation is consecutive to the incoming request or whether it relates to a spontaneous thread A₃. It is, therefore, impossible to propagate the context relating to incoming requests for object invocations.

Under such circumstances, propagating the context requires the code in the application objects to be modified. It is necessary to make an explicit request to the application to associate the context of the incoming request with the newly created thread A₂. Unfortunately, the code of application objects is not generally available to enable developers to perform this modification.

The infrastructure services offered by present distributed object systems thus do not make it possible to determine the causal order of invocations in a transparent manner.

### SUMMARY OF THE INVENTION

One object of the present invention is to enrich the services offered by such infrastructures in order to provide a transparent traceability property.

Thus, the technical problem to be solved by the subject matter of the present invention is to propose a method of propagating invocation contexts through a distributed object system, the system including an API interface for managing threads, and each object being associated with an interceptor and a manager of the context of the incoming request received by the interceptor during invocation of the object, which method makes it possible to determine the causal order of invocations in a transparent manner and thus to know the identities of objects involved in implementing a service, and also the order in which they are activated, without the objects themselves needing to intervene directly in the process, thus making it possible in particular to put into place a finely-tuned policy for controlling access.

One aspect of the present invention is directed to a method of propagating invocation contexts through a distributed object system, the system including an application management API interface and each object being associated with an interceptor and with a manager of the context of an incoming request received by the interceptor when the object is invoked. The method comprises providing a thread manager for the interceptor to, firstly, establish an association between a thread of an object directly consecutive to an incoming request invoking the object and the context of the incoming request as identified by the context manager and, secondly, to recover the context from the thread manager and associate it with the outgoing request from the object. The application management API interface is enabled to recover the current context from the thread manager and to associate it with any thread of the object indirectly consecutive to the incoming request.

Another aspect of the invention is directed to a method of propagating invocation contexts through a distributed object system, the system including an application programming interface that manages threads, and each object being associated with an interceptor and with a context manager for managing the context of an incoming request received by the interceptor when the object is invoked. The method comprises providing a thread manager for the interceptor to establish an association between a thread of an object directly consecutive to an incoming request invoking the object and the current context of the incoming request as identified by the context manager. The application programming interface is enabled to recover the current context from the thread manager and to associate it with any thread of the object indirectly consecutive to the incoming request. The associated context is recovered from the thread manager for the threads directly and indirectly consecutive to the incoming request invoking the object, and the recovered context is associated with an outgoing request from the object.

Thus, by creating an thread manager and by enriching the API offered by the development language for managing threads (creating, synchronizing, destroying, . . . ), the method of the invention makes it possible to keep up to date the associations between all types of thread and invocation context. These associations can subsequently be used by the interceptors to recover the contexts associated with outgoing requests.

Context propagation can then take place without requiring any further intervention by the application objects, thus making it possible to develop services that are totally transparent.

The method of the invention operates as follows. When the interceptor receives a request, it extracts the context and asks the thread manager to create an association between the context and the current thread directly consecutive to the incoming request. The invocation is then forwarded to the application object.

If this thread is used by the application object to invoke another object, then the interceptor can directly recover the context relating to the current thread by interrogating the thread manager, and can associate it with the outgoing request.

When the desired application object creates a new thread to invoke another object, it must make use of the enriched thread managing API. The new thread as created by this API, which thread is indirectly consecutive to the incoming request, inherits the context from the parent thread. It then suffices for the interceptor to recover the context of the current thread, i.e. the child thread, directly and to associate it with the outgoing request.

If the current thread is neither directly nor indirectly consecutive to an incoming request, then no context is associated therewith. This applies in particular when the application object spontaneously invokes another object. Under such circumstances, the thread has not been created for managing an incoming request. Nor is it a child of an thread dedicated to managing an incoming request. It is therefore associated with no context.

### BRIEF DESCRIPTION OF THE DRAWINGS

FIG. 1 shows a mechanism for invoking an application object in a known interceptor system.

FIG. 2 is a diagram of a distributed object system operating in accordance with the method of the invention.

FIG. 3 shows a variant of the FIG. 2 distributed system.

FIG. 4 shows operation of the context manager.

FIG. 5 shows the way a context is managed by the context manager.

FIG. 6 shows a first example where the invention could be relevant.

FIG. 7 shows a second example where the invention could be relevant, in which the location of the user is required to decide whether access is granted or denied.

FIG. 8 is a diagram depicting the relationship among an initiator, intermediaries and a target in a distributed object system, as known in the prior art.

### DETAILED DESCRIPTION OF THE DRAWINGS

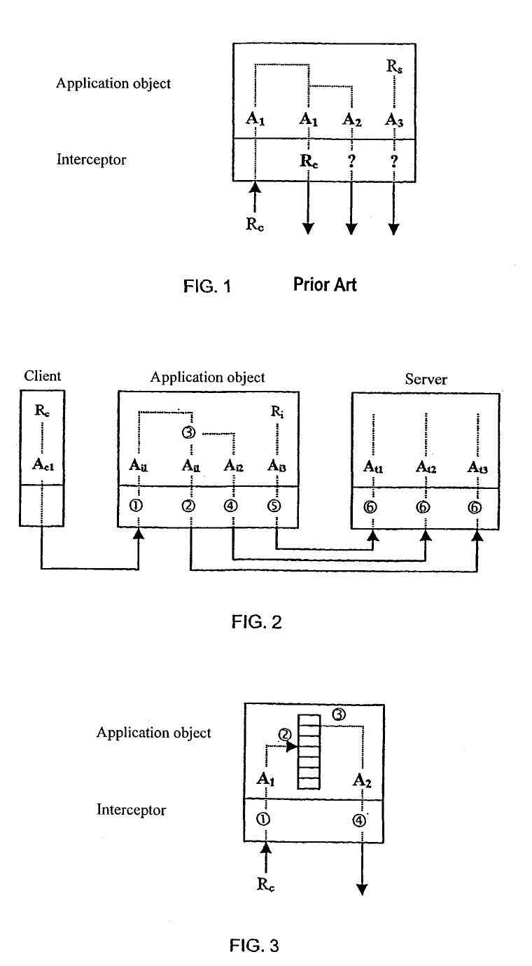

The description relates to the case where the expressed requirement for making the distributed object system of FIGS. 2 and 3 secure is to be able to propagate the particular context that consists in the identity of the client, initiator of the invocations, and to do so in transparent manner all the way to the server and through the application object.

The distributed system shown in FIG. 2 comprises a conventional API interface for managing threads defined by the standard Thread class, and including the method Thread( ).

The objects (client, application, and server) include interceptors suitable for modifying requests in order to add thereto and extract therefrom an invocation context, in particular the list of the identities of the objects involved in the chain of invocation.

Furthermore, provision is made for the interceptors to have a context manager, e.g. a Secure Socket Layer (SSL), between objects. See Alan O. Freier, Philip Karlton, Paul C. Kocher, “The SSL Protocol—Version 3.0,” Internet Draft, March 1996. Another option is to use Transport Layer Security (TLS). See T. Dierks, C. Allen, “The TLS Protocol—Version 1.0,” RFC2246, January 1999. These are used by interceptors to enable a server object to manage the context of an incoming request invoked by a client object.

The context manager performs the following functions:

Injecting the context into a request (on the client side)

Extracting the context from a request (on the server side)

Verifying the context

Authenticating the client

Enriching the context (e.g. with the identity of the client)

In order to be able to propagate invocation contexts through the distributed system, a thread manager ThreadManager is created (for illustration purposes, JAVA is used below as the programming language) which maintains the associations between threads and their context. In particular, it provides interceptors with the following methods:

to add a new association (setContext method) between the current thread and the new context corresponding to the incoming request (context parameter);

to recover the context, if any, associated with the current thread (getContext method); and

to delete the association between the current thread and its context (deleteContext method).

| | |
|---|---|
| Void | setContext(Object context) |
| Object | getContext() |
| Void | deleteContext() |

How to implement such methods can involve maintaining a (hash) table containing the contexts indexed by the identification of the threads. The specific implementation may vary depending on the programming language used. For example, in Java, these methods can be implemented as follows:

public class ThreadManager {

private static Hashtable contexts = new Hashtable( );
...
public static void setContext( Object context ) {

// Getting the name of the current thread
String threadName = Thread.currentThread() .getName();
// Updating the hash table with the new association
contexts.put( threadName,context );

}
public static void deleteContext( ) {

//Getrting the name of the current thread
String threadName = Thread.currentThread() .getName();
// Removing the corresponding association from the hash table
copntexts.remove( threadName );

}
public static Object getContext( ) {

// Getting the name of the current thread
Thread thread = Thread.currentThread( );
// Returning the associated context
return contexts.get( thread.getName( ) );

}

}

Similarly, transparent propagation of contexts requires the thread management API to be enriched in order to associate the current context with a new thread created by the application object.

Two methods are possible for enriching an API: modifying the API offered by the programming language or developing a specific API that inherits from the standard API and that enriches the methods it makes available. The first approach offers a maximum level of transparency. However it requires the sources of the development language to be available, and that is not always possible. The example described herein consists in developing a specific API using the second approach.

A class FtThread serves to associate a context with each of its instances. This class inherits from the standard Thread class and offers the same constructors (i.e. the same signatures). An additional method getContext serves to recover the context associated with a thread.

| | |
|---|---|
| | FtThreaqd() |
| | FtThread() (Runnable target) |
| | FtThread() (Runnabl;e target,String name) |
| | FtThread() (String name) |
| | FtThread() (ThreadGroup group,Runnable target) |
| | FtThread() (ThreadGroup group,Runnable target,String name) |
| | FtThread() (ThreadGroup group,String name) |
| Object | GetContext() |

In order to enable information to propagate, application objects must use this class for creating threads.

The way to implement this may vary depending on the programming language used. For example, in Java, this can be implemented as follows:

public class FtThread extends Thread {

Object context;
public FtThread() {

// Creating a standard thread
super();
// Initializing the associated context
init();

}
public FtThread(Runnable target) {

// Creating a standard thread
super(target);
// Initializing the associated context
init();

}
public FtThread(Runnable target,String name) {

// Creating a standard thread
super(target,name);
// Initializing the associated context
init();

}
public FtThread(String name) {

// Creating a standard thread
super(name);
// Initializing the associated context
init();

}
public FtThread(ThreadGroup group,Runnable target) {

// Creating a standard thread
super(group,target);
// Initializing the associated context
init();

}
public FtThread(ThreadGroup group,Runnable target,String name) {

// Creating a standard thread
super(group,target,name);
// Initializing the associated context
init();

}
public FtThread(ThreadGroup group,String name) {

// Creating a standard thread
super();
// Initializing the associated context
init();

}
private void init() {

// Getting the current thread
Thread father = Thread.currentThread();
try {

// Checking whether it is of type FtThread
FtThread ftThread = (FtThread)father;
// If so, getting the context directly from the thread
context = ftThread.getContext();

}
catch(ClassCastException e) {

// If not, getting the context from the Thread Manager
context = ThreadManager.getContext(father.getName());

}

}
public Object getContext() {

// Returning the context directly associated with the current

thread

return context;

}

}

By way of example, in Java two methods are possible for creating a thread. The first consists in creating a class that inherits from the class FtThread.

public class ExtendThread extends FtThread {

ExtendThread() {. . .}
public void run() {. . .}

}

The thread is then created and executed as follows:

ExtendThread thread = new ExtendThread(target)
thread.start()

The second method consists in creating a class that implements the interface Runnable.

public class ImplementThread implements Runnable {

ImplementThread() {. . .}
public void run() {. . .}

}

The thread is then created and executed in the following manner:

ImplementThread thread = new ImplementThread()
new FtThread(thread).start()

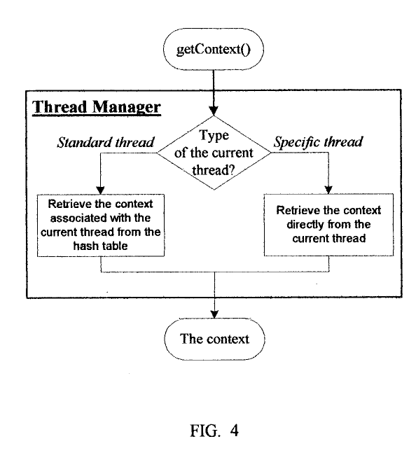

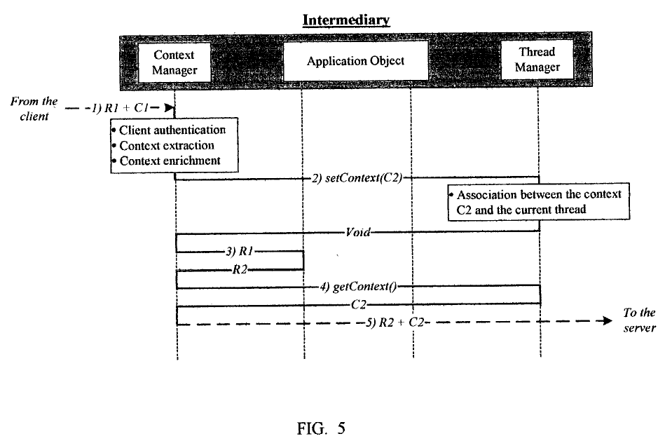

The way the thread manager retrieves the context associated with this type of specific/customized thread differs from the way to retrieve the context associated with a standard thread. If the current thread is a standard thread, the thread manager must retrieve the associated context from the hash table it manages (attribute contexts of the class ThreadManager). On the contrary, if the current thread is a specific thread (i.e. a thread of type FtThread), the thread manager must retrieve the associated context directly from this thread (by using the method getContext of the class FtThread). The thread manager must therefore behave as shown in FIG. 4, which is self-explanatory.

For example, in Java, the method getContext of the ThreadManager API would be implemented as follow:

public class ThreadManager {

...
public static Object getContext ( ) {

// Getting the current thread
Thread thread = Thread.currentThread();
try {

// Checking whether it is of type FtThread
FtThread ftThread = (FtThread)thread;
// If so, returning the context directly associated with

the

// thread
return ftThread..getContext();

}
catch(ClassCastException e) {

// If not, returning the context retrieved from the Thread
// Manager
return contexts.get(thread.getName());

}

}

}

FIG. 5 shows the way a context is managed in the simplest case, i.e. in the case where the application object does not create a new thread.

1. A client sends a request R1 to an intermediary. This request contains a context C1. The context manager intercepts the request, authenticates the client, extracts the context and enriches it with the identity of the client.

2. The context manager asks the thread manager to associate the new context C2 with the current thread.

3. The context manager forwards the request R1 to the application object. The processing of this request requires the application object to send another request R2 to a server.

4. The context manager intercepts the request R2 and retrieves the context associated with the current thread by asking the thread manager. This context is the context C2.

5. The context manager injects the context C2 into the request R2 and forwards it to the appropriate server.

The context propagation method of the invention operates using the following operations as shown in FIG. 2:

1) when the interceptor of the application object receives a request, it authenticates the client, creates a context containing the identity of the client, and associates this context with the current thread Aᵢ₁, directly consecutive to the incoming request, using the created thread manager Threadmanager;

2) if the application object uses the same thread A_{I1} to invoke the server, the interceptor recovers the context associated with the thread by using the thread manager ThreadManager and it inserts the identity of the client in the request as sent;

3) in order to create a new thread Aᵢ₂, indirectly consecutive to the incoming request, and use it for invoking the server, the application object must use the enriched thread managing API FtThread. The new thread Aᵢ₂ as created in this way is then associated transparently with the context of the thread Aᵢ₁;

4) the thread manager ThreadManager enables the interceptor to recover the context associated with the thread A_{I2} and to add the client identity to the outgoing request;

5) when the application object invokes the server spontaneously, i.e. using a thread Aᵢ₃ that has not been created by receiving a request, the interceptor can then verify that the current thread Aᵢ₃ is not associated with any request. The identity of the client is therefore not added to the outgoing request; and

6) on receiving a request, the interceptor of the server authenticates the application object and extracts the context associates with the request. It can then determine what path has been followed by the received request.

The server can also use the thread manager ThreadManager to recover the context associated with the current thread and thus to determine the path followed by the request.

To retrieve the context associated with a given invocation, an application object has just to use the getContext method of the thread manager. Therefore, a programmer just has to add the following code line:

Object context = ThreadManager.getContext( );

FIG. 3 shows a variant of the method of the invention in which the application object stores the incoming requests in a message queue and uses a pool of threads (“pool of threads” refers to a finite set of pre-created threads that are in charge of getting the messages from the message queue and sending them to the appropriate destination) for transmitting received requests to the appropriate destinations. The APIs that are available are no longer sufficient for enabling information to be propagated transparently. These threads are not associated with any context.

However, the APIs do enable developers of security services to make available APIs that enable this type of special case to be managed. In the example described with reference to FIG. 3, it suffices for developers to create an API to manage a message queue and that offers two methods in particular (put and get) enabling messages to be put into the queue and to be recovered therefrom, respectively. The put method enables the context of the current thread to be associated with the message put in the queue. The get method enables the context of the extracted message to be associated with the current thread.

The variant of FIG. 3 operates as follows:

1) the interceptor determines the context of the incoming request and associates it with the current thread A₁, using the thread manager ThreadManager;

2) the application object uses the put method to insert the message in the message queue. The context of the current thread A₁ is associated in transparent manner with the message;

3) the application object takes the message from the message queue by using the get method. The context of the message is associated with the current thread A₂; and

4) the interceptor recovers the context of the current thread A₂.

The way to implement such methods may vary depending on the programming language used. For example, in Java, this such methods can be implemented as follows:

public class MsgQueueManager {

...
public static void put( Object msg ) {

// Getting the context associated with the current thread
Object context = ThreadManager.getContext ( );
// Updating the message queue with the new association

context/msg

...

}
public static Object get ( ) {

// Getting the next message
Object msg = ...;
// Getting the associated context
Object context = ...;
// Creating a new association between the current thread and

the

// context
ThreadManager.setContext ( context );
// Returning the message
return msg;

}

}

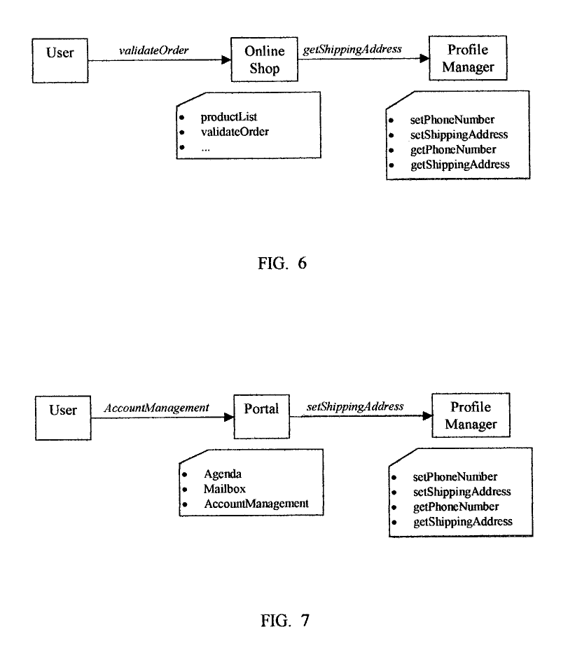

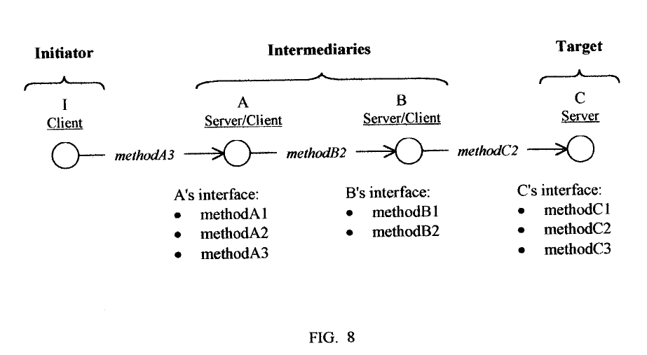

FIG. 6 shows a first example where the invention could be relevant. Three following actors are involved in this example:

A User wishing to make a purchase.

A Profile Manager hosting information about the User (e.g. phone number, postal address, shipping address, wallet).

An Online Shop that is a web server providing goods.

Access to the services of these different servers may depend on the context in which they are accessed. For example, to deliver a product to a user, the online shop needs to retrieve the user's shipping address by asking the Profile Manager. Access to this information may depend on the identity of both the user and the Online Shop. Therefore, the user's identity needs to be propagated to the profile manager so it can check whether the information can be delivered or not.

In the scenario of FIG. 6, the (invocation) context corresponds only to the identities of the user and the Online Shop (i.e. the intermediary). However, it can also contain any other information. In fact it can contain any information that is required to take a decision on whether the access to a service is granted or not. For instance, access control can be based on, not only on the identity of the user, but also on his location. FIG. 7 shows a second example where the location of the user is required to decide whether access is granted or denied. Three following actors are involved in this example:

A User having an Internet access account.

A Portal (i.e. a web-oriented desktop) that is a web server providing Users with a number of services (e.g. mailbox, account management, agenda)

A Profile Manager hosting information about the User (e.g. phone number, postal address, shipping address, wallet).

In this scenario, to change his/her shipping address, the user uses the AccountManagement service the portal provides to enter his/her new shipping address. When the user validates the modification, the portal invokes the setShippingAddress method of the Profile Manager. Access to this method is allowed only for the owner of the information. It can also be restricted to users that are connected from their home (i.e. by using their own Internet access account). In this scenario, the (invocation) context must, therefore, contain both the identity of the user and its IP address.

It should be noted that the thread manager and context manager can be parts of the same interceptor, or they can be in two distinct interceptors acting sequentially.

1. A method of propagating invocation contexts through a distributed object system, the system including an application management API interface and each object being associated with an interceptor and with a manager of the context of an incoming request received by the interceptor when the object is invoked, the method comprising:
providing a thread manager for the interceptor to, firstly, establish an association between a thread of an object directly consecutive to an incoming request invoking the object and the context of the incoming request as identified by the context manager and, secondly, to recover the context from the thread manager and associate it with the outgoing request from the object; and
enabling the application management API interface to recover the current context from the thread manager and to associate it with any thread of the object indirectly consecutive to the incoming request.

2. A method according to claim 1, further comprising providing an API interface for managing a message queue to put a message in the queue and associate the context of the current thread with the message put in the queue.

3. A method according to claim 1, further comprising providing an API interface for managing a message queue to take a message from the queue and associate the context of the taken message with the current thread.

4. A method of propagating invocation contexts through a distributed object system, the system including an application programming interface that manages threads, and each object being associated with an interceptor and with a context manager for managing the context of an incoming request received by the interceptor when the object is invoked, wherein the method comprises:
providing a thread manager for the interceptor to establish an association between a thread of an object directly consecutive to an incoming request invoking the object and the current context of the incoming request as identified by the context manager;
enabling the application programming interface to recover the current context from the thread manager and to associate it with any thread of the object indirectly consecutive to the incoming request; and
recovering the associated context from the thread manager for the threads directly and indirectly consecutive to the incoming request invoking the object, and associating the recovered context with an outgoing request from the object.
